(19) United States
(12) Patent Application Publication
(10) Pub. No.: US 2005/0057507 A1
(43) Pub. Date: Mar. 17, 2005

(54) Roller structure for a computer mouse

(76) Inventor: Kuo Shu Cheng, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/765,077

(22) Filed: Jan. 28, 2004

(30) Foreign Application Priority Data
Sep. 17, 2003 (TW) 92216708

(51) Int. Cl. G09G 5/08

(52) U.S. Cl. 345/163

(57) ABSTRACT

A roller structure for a computer mouse has a roller member with a concave portion formed on a circumference surface thereof. The concave portion is concaved from top to bottom of the circumference surface of the roller member to form an arcuate shape. Furthermore, the roller structure can be provided for ergonomics and a simple design, and to decrease operational injuries to a user's finger.

### BACKGROUND OF THE INVENTION

1. Field of the Invention

The present invention relates to a roller structure for a computer mouse and, more particularly to a roller structure having a concave portion formed on an operating surface for providing some advantages, such as an ergonomics and simple design, and to decrease operating injuries to fingers.

2. Description of the Related Art

Since the advent of the computer, the interface between the user and the computer has remained essentially stable. A typical computer is usually equipped to use a mouse for controlling the movement of the cursor. Computer mice employ mechanical, optical or other means to control the displacement of a cursor on a computer screen. Mouse usage is coming under increasing scrutiny because while providing the computer user with considerable flexibility over the motion of the cursor on the computer screen, extended or repeated use of the mouse can result in severe physical strain. This physical strain develops because, for the hand, even the smallest of postural shifts can increase or decrease stresses on the hand and fingers. Many mouse designs attempting to eliminate wrist injuries are based on ergonomics and comfort of the user; however, the mouse was designed without sufficient consideration for the best postures of the fingers. The reported number of mouse over-use related injuries is increasing and in some industries the injury rates rival and even surpass those of keyboard-related injuries.

In addition to the movement sensing system, mice are generally equipped with at least one roller for selecting and initiating computer function, i.e. the rollers can be used to move a cursor in a displayed electronic document. Furthermore, when operating the rollers, the finger of the user must be stretched to contact the front-most of the roller, and then press the roller to roll backward; or the finger of the user abuts against the backmost of the roller, and then presses the roller to roll forward. When the user wants to quickly review the document on the computer screen, the finger needs to stretch, bend and press constantly, which action gradually lead to repetitive stain injuries (RSI). Repetitive stain injury refers to the many ailments associated with repetitive motions and static pressure/loading.

With reference to FIG. 1, a conventional computer mouse 1 includes a mouse body and a roller 12 having an upper end protruding out of the mouse body. When the roller is operated, the finger of the user must be stretched to contact the front-most of the roller 12, and then press the roller 12 to roll backward. Conversely, the finger of the user also abuts against the backmost of the roller 12, and then presses the roller 12 to roll forward.

### SUMMARY OF THE INVENTION

It is therefore a principal object of the invention to provide a roller structure, which can be achieved as an ergonomics and simple design, and decreases operational injuries to a finger. Furthermore, the present invention has been accomplished to eliminate the aforesaid problem.

To achieve the above object, the present invention provides a roller structure, which includes a roller member having a concave portion formed on a circumference surface thereof. The concave portion has two sides and a center lower than the two sides relative to an axial line of the roller member. The concave portion is concaved from top to bottom of the circumference surface of the roller member to form an arcuate shape. The concave portion includes a plurality of strips thereon for increasing friction during use. A thickness of the roller member has a predetermined value between 6 mm and 15 mm.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a schematic view of a roller structure for a computer mouse of a prior art;

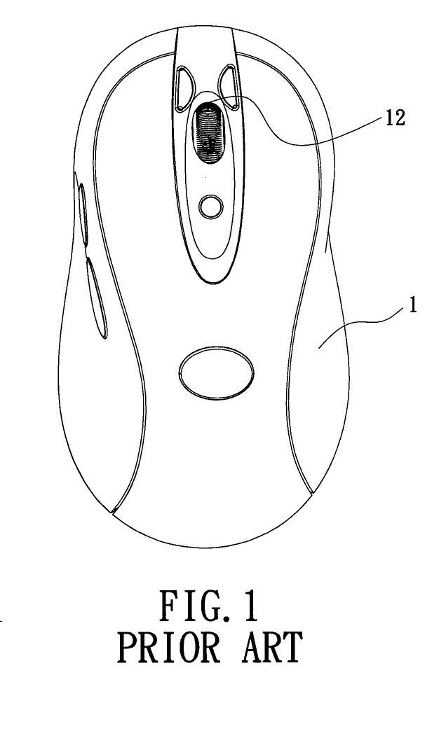

FIG. 2 is a schematic view of a roller structure for a computer mouse of the present invention; and

FIG. 3 is a perspective view of the roller structure of the present invention.

### DETAILED DESCRIPTION OF THE EMBODIMENTS

Wherever possible in the following description, like reference numerals will refer to like elements and parts unless otherwise illustrated.

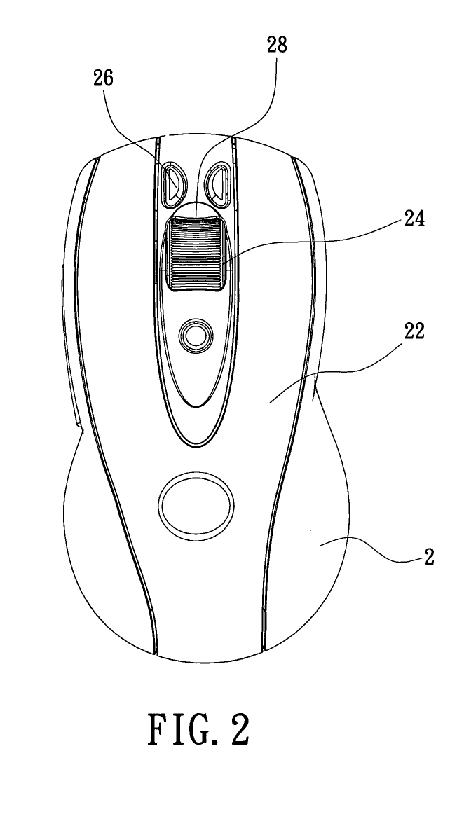

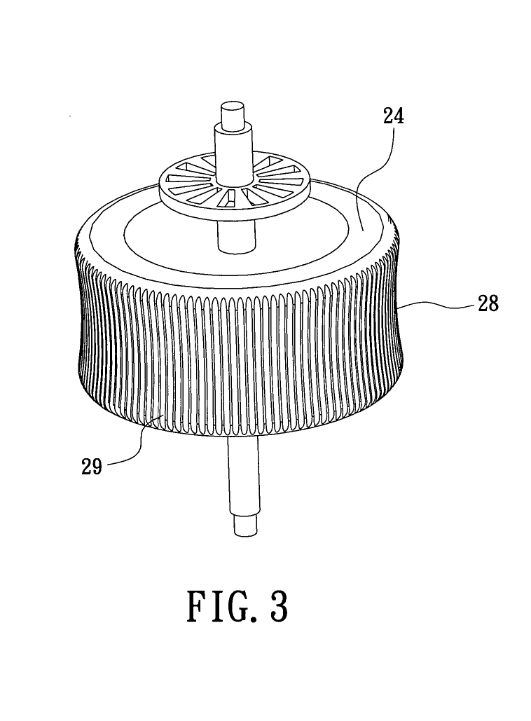

With reference to FIGS. 2 to 3, the present invention provides a computer mouse 2 including a mouse body 22, a third-axis input device having a roller structure and at least two buttons 26 arranged on the mouse body 22. The roller structure has a roller member 24 defining a lateral thickness larger than that of a roller member in market conditions (the thickness of the roller member is between about 6 mm and 15 mm). The roller member 24 has a concave portion 28 formed on a circumference surface thereof. The concave portion 28 is concaved from top to bottom of the circumference surface of the roller member 24 to form an arcuate shape (i.e., the concave portion 28 has two sides and a center lower to the two sides relative to an axial line of the roller member 24) for adapting to different sizes of fingers. The concave portion 28 has an extremely smooth arcuate surface on its inner wall. The concave portion 28 includes a plurality of strips 29 laterally arranged on the inner wall. Using a friction between the strips 29 and the finger enables the roller member 24 to easily turn. When not in use, the finger can comfortably lie on the roller member 24. During use, the roller member 24 needs only to be lightly turned, and the finger need not be constantly bent.

The strips 29 on the concave portion 28 can be displaced by rhombus patterns or triangle patterns (not shown) for increasing the friction between the finger and the roller.

The concave portion 28 can be applied on single-wheel mouse, double-wheel mouse or multi-wheel mouse.

Moreover, the computer mouse of the present invention employs the above-mentioned structure to design a roller structure with a concave portion (concave surface) substituted for a conventional roller structure with a convex surface, thereby to enable the finger to lie on the concave surface of the roller structure for further operation. In addition, the concave portion of the roller structure has a very smooth arcuate shape, and the thickness of the roller structure is larger than the conventional roller structure for adapting to various lo sizes of fingers. The strips on the concave surface of the roller structure can be used to increase the friction in use.

In the larger size of concave surface of the roller structure provided, the finger doesn't need to bend upwardly. The finger is placed naturally on the concave surface, and turns the roller structure lightly so as to achieve the general function. Therefore, the finger can be put on the concave surface which has given rise to the term, “ergonomic”; that is, the correct operating position for the user when using the computer mouse for long periods of time in order to alleviate and avoid the unnatural and unnecessary stress on the finger of the computer user.

There has thus been described a new, novel and heretofore unobvious roller structure which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

1. A roller structure for a computer mouse having a mouse body, a third-axis input device and at least two buttons, comprising:
a roller member having a concave portion formed on a circumference surface thereof.

2. The roller structure of claim 1, wherein the concave portion has two sides and a center lower than the two sides relative to an axial line of the roller member.

3. The roller structure of claim 2, wherein the concave portion is concave from top to bottom of the circumference surface of the roller member to form an arcuate shape.

4. The roller structure of claim 1, wherein the concave portion includes a plurality of strips thereon for increasing a friction in use.

5. The roller structure of claim 1, wherein a thickness of the roller member has a predetermined value of between about 6 mm and 15 mm.
